(19) United States
(12) Patent Application Publication
(10) Pub. No.: US 2003/0201885 A1
(43) Pub. Date: Oct. 30, 2003

(54) Vehicular throttle idle signal indication

(76) Inventor: Joseph Edward Currie, Webster, NH (US)

Correspondence Address: Joseph E. Currie, 506 White Plains Rd., Webster, NH, 03303-7112, US

(21) Appl. No.: 10/102,347

(22) Filed: Mar. 21, 2002

(51) Int. Cl. B60Q 1/26

(52) U.S. Cl. 340/468

(57) ABSTRACT

A new illuminated signal to following vehicle drivers is disclosed. This signal would inform the driver of the following vehicle that the driver of the lead vehicle had removed accelerator pedal pressure. The following vehicle driver may anticipate the deceleration and braking of the lead vehicle. So fore-warned, the driver of the following vehicle may also remove accelerator pressure, preventing the following vehicle from inappropriately approaching the rear of the lead vehicle, and the need for heavy brake action. This advance warning of lead vehicle deceleration and braking will decrease the reaction time needed by following vehicle drivers to safely brake after the lead vehicle brake light is observed, reducing the potential for rear-end collisions. This new light signal, indicating removal of accelerator pedal pressure in the lead vehicle, would cease whenever the lead vehicle brake is applied, or the cruise control is switched on.

### STATEMENT REGARDING FEDERALLY SPONSORED RESEARCH OR DEVELOPMENT

Not Applicable

### BACKGROUND OF INVENTION

This invention relates to the communication of vehicular throttle idle position to following vehicles, especially automotive vehicles.

Following a series of tests in which the benefits of additional signaling to the driver of a trailing motor vehicle were illustrated; the U.S. Government mandated high mounted brake signals on new vehicles since the mid 1980's. In a test of the additional higher visibility brake signals on a large number of taxicabs in Washington D.C., (see Malone, 986, one of the reference publications identified subsequently herein), the number of rear-end collisions involving these taxicabs was reduced by 54%. Even with the higher visibility additional brake indication, rear-end accidents still account for about 37% of all multi-vehicle accidents, (McKnight reference, 1992). The present invention seeks to enhance the proven benefit of additional signaling to the following vehicle drivers. The signaling of complete, or near complete, removal of accelerator pedal pressure in the lead vehicle, will alert the driver of the following vehicle to expect lead vehicle deceleration, and possible brake application. The system of the present invention will serve to warn following vehicle drivers of lead vehicle deceleration, and the possibility or probability, depending on the driving situation, of lead vehicle brake action.

This advance warning will reduce the reaction time needed by the following vehicle driver to react to the brake light indication of the lead vehicle, by alerting said following vehicle driver to remove accelerator pedal pressure, and prepare to apply the brakes. If this system is used in large numbers of vehicles on the road, and becomes universally recognizable, the reduction in brake reaction time by the drivers of following vehicle cars, vans, and all trucks, will very likely reduce the number of rear-end collisions, thereby saving lives.

### SUMMARY OF INVENTION

This invention provides throttle idle information in an attention-capturing manner to the following vehicle driver, or a driver approaching from the rear.

The present invention seeks to reduce brake application reaction time of following vehicle drivers by presenting the drivers of following vehicles with a light indication that indicates complete, or mostly complete, removal of accelerator pedal pressure by the lead vehicle driver. A driver of a following vehicle, so alerted, can prepare to slow or apply brakes. According to the invention, a switch activated by a selectable minimal voltage from the throttle position sensor, or activated by the throttle idle position of the throttle cable, pedal or linkage, would illuminate either a high mounted center amber lamp, or amber lamps in the conventional vehicle left and right, rear light clusters. Said amber lamp or lamps would illuminate in a steady manner, so long as the switch condition indicated no throttle application, and until brake application.

Brake application would open this electrical circuit to the amber lamp or lamps, inhibiting the steady amber throttle idle indication, as throttle idle indication is inconsequential to the following vehicle driver, after brake application by the lead vehicle. The present invention inhibits the throttle idle light indication so long as the vehicle cruise control is on because the vehicle is seeking to maintain a constant speed even when no pressure is applied to the accelerator by the cruise control. The present invention also provides for the dual use of amber directional lamps, similar to the conventional dual use of red brake, directional lamps, in that the amber directional lamps can function as both directional lamps, and throttle idle indication. This dual use is accomplished by first passing vehicle electrical power through the throttle idle switch, second through a relay contact controlled by the brake circuit, and third through a separate directional signal sensing relay contact, and an isolation diode, to each of the two amber directional lamps. If a turn signal is initiated after a throttle idle indication, the amber lamp on the signaled side will flash, and the amber lamp on the non signaled side will continue to illuminate steady, similar in operation to the red brake lights on, followed by either left or right red turn signal operation. If a separate high mounted amber throttle idle indicator lamp is used, no isolation diode or directional sensing relay is required, and it is unaffected by turn signal operation, but is inhibited by brake application, and is inhibited by operation of the vehicle cruise control to the on condition.

It is an object of the present invention to provide a throttle idle visual signal to the driver of a following vehicle.

It is another object of the invention to provide the throttle idle visual signal by way of one or a plurality of different signaling elements, in either a steady or flashing mode.

It is another object of the invention to inhibit throttle idle indication by brake application.

It is another object of the invention to inhibit throttle idle indication by operating the vehicle cruise control to the on condition.

It is another object of the invention to use either a rear center high mounted amber indication, rear left and right side amber indication, mounted either on the rear window interior deck or rear fender areas, or both center and left and right side indication to signal throttle idle.

It is another object of the invention to utilize the present amber directional lamps on the rear left and right side in a dual mode, functioning as both directional turn indicators, and as throttle idle indicators.

It is another object of the invention that colors used for throttle idle signal illumination be approved by appropriate federal or state agencies.

Additional objects and features of the invention will be understood from the following description and claims and the accompanying drawings.

These and other objects of the invention are achieved by motor vehicle signaling apparatus comprising the combination of:

a first vehicle-received rear mounted electrically responsive visual signaling device disposed on the rear of said vehicle, in a position of good visibility to an operator's position in a second trailing vehicle;

means for energizing said first vehicle electrically responsive visual signaling device from a first vehicle energy source, in response to throttle idle condition of said first vehicle;

means for inhibiting said first vehicles electrically responsive visual signaling device by operation of the brake system of said first vehicle;

means for inhibiting said first vehicle electrically responsive visual signaling device by operating the vehicle cruise control to the on condition.

### BRIEF DESCRIPTION OF DRAWINGS

FIG. 1 shows typical rear mounted throttle idle indication lamps and their physical arrangements for all vehicles, other than motorcycles.

FIG. 2 shows the physical arrangement for rear window interior deck mounted throttle idle signal lamps.

FIG. 3 shows a typical center high mounted throttle idle indication lamp physical arrangement for a small truck or sport utility vehicle.

FIG. 4 shows a simplified electrical schematic diagram for the operation of a FIG. 1 and FIG. 2 typical rear mounted throttle idle indicationl lamps according to the present invention.

FIG. 5 shows a simplified electrical schematic diagram for the operation of a FIG. 3 typical center high mounted throttle idle indication device according to the present invention.

### DETAILED DESCRIPTION

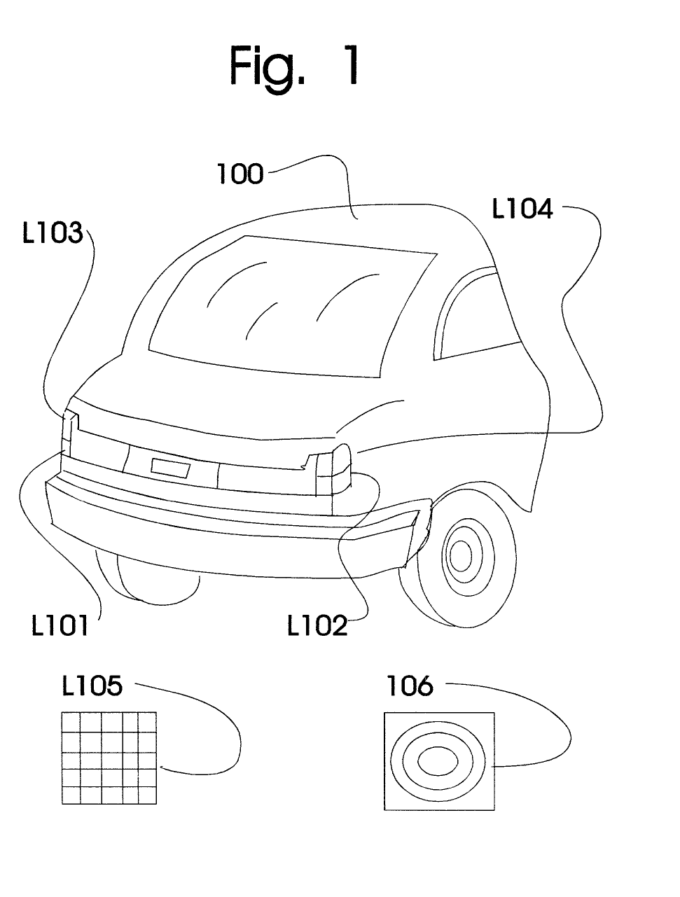

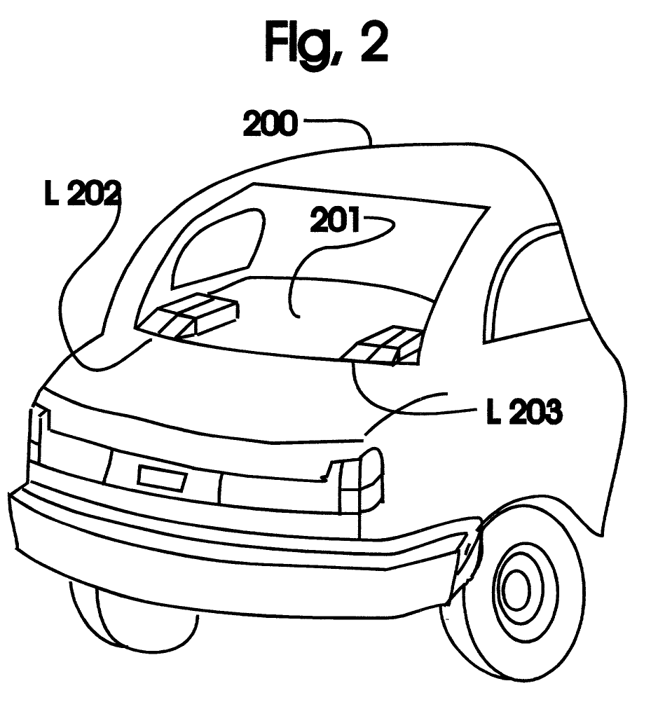

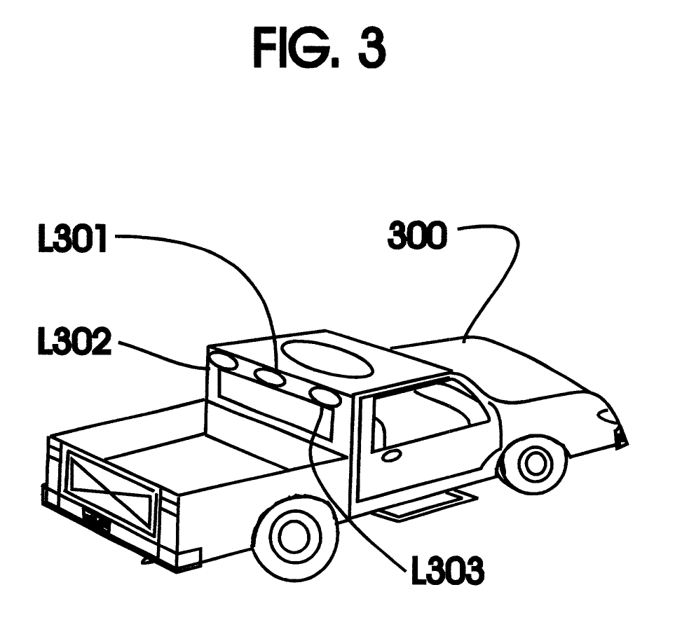

FIG. 1, FIG. 2, and FIG. 3 drawings show three typical physical lamp arrangements for throttle idle signal lights on present day motor vehicles.

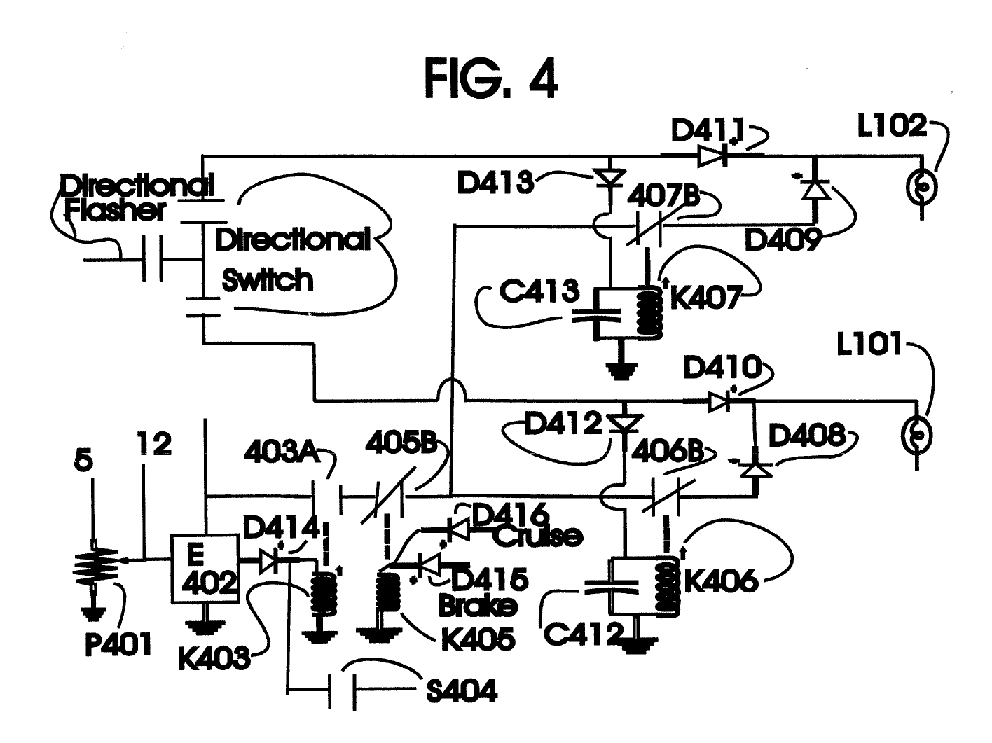

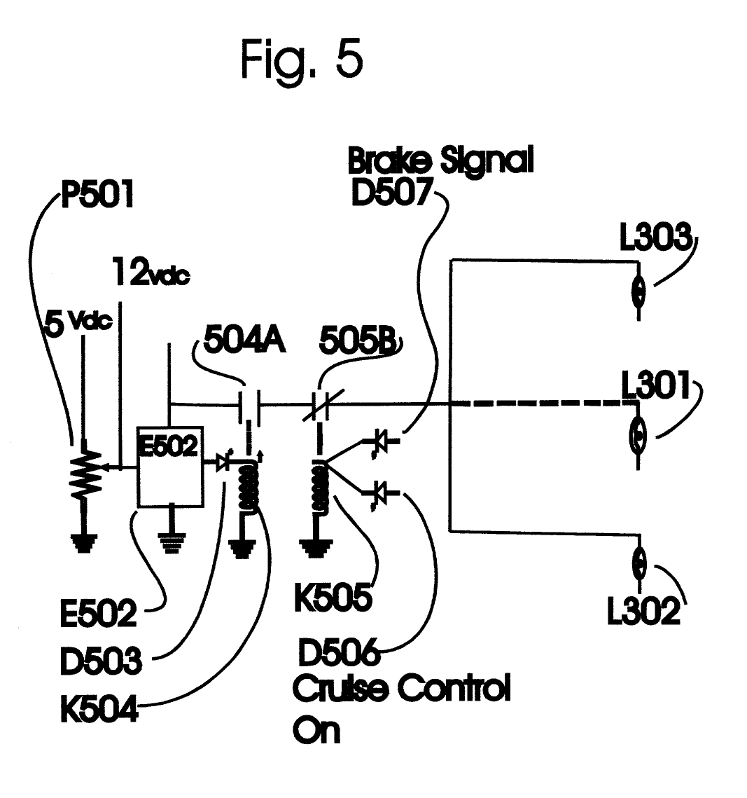

In the FIG. 1 drawing a sedan type vehicle 100 is viewed from behind. Disposed in the left and right rear fender areas are the combination turn signal and throttle idle signal lamps L101 and L102, or separate throttle idle signal lamps L103 and L104. Signal lamps L101, L102, L103, and L104 may be comprised of a plurality of individual light-emitting elements L105, which may be of the incandescent filament, or of the light emitting diode type. An amber colored cover lens or filter 106, may or may not be used to exclude other colors in the output, and to obscure individual illuminating elements. Combination signal lamps L011 and L102 may be wired per the schematic diagram depicted in FIG. 4 Separate throttle idle lamps L103 and L104 of FIG. 1 are wired per the simplified electrical diagram depicted in FIG. 5.

FIG. 2 drawing shows a sedan 200, a rear window and window deck 201, with left L202 and right L203 throttle position idle indication lamps. Said lamps L202 and L203 are mounted on the deck against the rear window in the interior of the vehicle, and are covered with light tight enclosures that prevent the light radiation from being visible except from behind the vehicle. Lamps L202 and L203 may be OEM wired as amber directional lamps and converted to dual use directional and throttle idle indication lamps by wiring per the simplified schematic diagram of FIG. 4, or wired as stand alone throttle idle signal lamps by wiring per the simplified schematic shown in FIG. 5.

FIG. 3 drawing depicts a center high mounted throttle idle lamp L301 on a small truck 300. Lamp L301 is wired per the simplified schematic of FIG. 5.

FIG. 3 also shows an alternative to single lamp L301, which is two throttle idle lamps, L302 on the left and L303 on the right. Lamps L302 and L303 could be wired as stand alone throttle idle signals per the simplified schematic of FIG. 5, or as combination turn signal and throttle idle lamps per the simplified schematic shown in FIG. 4.

In the FIG. 4 simplified schematic, throttle idle relay K403 is energized either by electronic circuit E402, through isolation diode D414, that has input from electrical throttle position sensing potentiometer P401, or else by closure of electromechanical switch S404, that is operated alternatively by the mechanical throttle cable or linkage in the throttle idle position. Electronic circuit E402 has a very high input impedance as found when using a field effect transistor input so as to minimize any loading effect on the throttle position sensor voltage supplied to the vehicle PCM, or power-train control module. When Throttle Position Sensing potentiometer P401 outputs a voltage in a range between 0.95 and 0.26 volts dc, the idle voltage range of most TPS units arrived at when the vehicle throttle is at a minimum, (foot pressure removed from the accelerator pedal), electronic circuit E402 outputs a voltage sufficient to operate relay K403 and close relay contact 403A. Closure of relay contact 403A allows a continuous flow of vehicle source electrical energy to and through normally closed brake relay contact 405B, and through the normally closed directional signal sensing relay contacts 406B and 407B, and through both isolating diodes D408 and D409, to amber throttle idle signal lamps L101 and L102.

If at this time, the coil of relay K405 senses vehicle source electrical energy through diode D415 as a result of vehicle brake application, relay contact 405B will open and interrupt the flow of source electrical energy to signal lamps L101 and L102, which will extinguish the amber throttle idle signal lamps as the red brake lamps illuminate. If vehicle braking is initiated before the engine speed returns to the idle range, relay K405 will energize through D415 and open normally closed contact 405B preventing the throttle idle lamps from illuminating. If the vehicle cruise control is operated to the on condition, vehicle source electrical energy passing through said cruise control on switch will operate relay K405 through diode D416, and inhibit the throttle idle signal lamps. Lamps L101 and L102 are combination directional signal lamps and throttle idle signal lamps.

In the FIG. 4 simplified schematic, note that the combination directional lamps and throttle idle signal lamps L101 and L102 are functional as independent directional lamps during the time that the (brake system on), (cruise control on) sensing relay K405 is energized, and the normally closed contact 405B is open, with no interactive effect, because of isolating diodes D408 and D409.

In the FIG. 4 simplified schematic, if the combination directional lamps and throttle idle signal lamps L101 and L102 are both energized because the series contacts 403A, 405B, and the series parallel contacts 406B and 407B are all closed, indicating to the following vehicle driver that the driver of the lead vehicle has removed foot pressure from his accelerator pedal, and the vehicle original equipment left directional signal is operated to the ON position, left directional signal energizing power is connected in a pulsing sequence through diode D412 to the parallel circuit of relay K406 and capacitor C412, and through isolating diode D410, to energize lamp L101, which is presently energized also through diode D408. The first electrical energy pulse from the left directional power source will conduct through diode D412; energize relay K406 and charge capacitor C412. Relay K406 will operate and stay operated during the time between said electrical energy pulses from the left directional signal power source, because capacitor C412 will discharge through the coil of relay K406 between left signal energy pulses. Capacitor C412 must discharge through the coil of relay K406 because of the blocking action of diode D412. The normally closed contact 406B will open and stay open, blocking the constant flow of electrical energy from the throttle idle electrical energy source, originating through relay contact 403A, from going to the left combination signal and throttle idle signal lamp L101. L101 will continue to receive left turn signal energy pulses in this manner, through diode D410, until the left turn switch is returned to the neutral position.

During this left turn signal operating sequence, the vehicle right side combination lamp L102 will remain constantly energized by the throttle idle electrical energy source originating through relay contact 403A, until either accelerator pedal pressure is reapplied, raising the signal voltage from throttle position potentiometer P401 to electronic circuit E402 above the operating thresh hold voltage, or the vehicle operator applies brake pressure energizing relay K405 and opening contact 405B. This same operating scenario is mirrored by the operation of the vehicle right directional signal and electrical components associated with the right side combination directional signal and throttle idle signal lamp L102.

In the FIG. 5 simplified schematic, throttle position-sensing potentiometer P501 outputs a dc voltage between 0.95 and 0.26 vdc when foot pressure is removed from the accelerator pedal and the engine speed returns to idle. This voltage is connected to the high impedance input of electronic circuit E502 that outputs a dc current through isolation diode D503 sufficient to energize relay K504. The normally open contact 504A closes and vehicle source electrical power flows through 504A, through normally closed contact 505B, to energize throttle idle signal lamps L302 and L303, or the single high mounted lamp L301. If foot pressure is applied to the accelerator pedal and engine speed is increased above the idle thresh hold output voltage of 0.95 vdc from potentiometer P501, relay K504 will de-energize and open contact 504A, removing electrical energizing power from throttle idle signal lamps L302 and L303, or lamp L301. If vehicle brake pressure is applied while the throttle idle lamps are illuminated, indicating that foot pressure has been removed from the vehicle accelerator pedal, relay K505 will energize through diode D507 and open relay contact 505B, removing electrical energy from throttle idle signal lamps L302 and L303, or L301. If the vehicle brakes are applied before the engine speed returns to idle, relay K505 will energize through diode D507 and open contact 505B before relay contact 504A closes, preventing the throttle idle signal lamps from energizing. Operating the vehicle cruise control to the on condition will disable the throttle idle indication by energizing the coil of relay K505 through diode D506 and opening normally closed contact 505B, until the cruise control is operated to the off condition.

The present invention may be provided as a retrofit kit for installation on older vehicles.

What is claimed is:

1) Throttle position responsive vehicular rear facing status light apparatus comprising the combination of:
visible light generating electrical energy to optical energy transducer apparatus disposed in a rearward facing orientation on a rearward portion of a first vehicle, in either the traditional left and right fender areas, the rear window deck area, or a center high-mount position;
a first vehicle-received source of electrical energy capable of energizing said visible light generating electrical energy to optical energy transducer apparatus;
electrical circuit apparatus connected in an electrical energy flow-controling relationship between said one or more visible light generating electrical energy to optical energy transducer apparatus and said first vehicle-received source of energy;
said electrical circuit apparatus including a first continuously closable electrical switch element responsive to vehicle throttle idle position in said first vehicle, and generating a continuous electrical energy flow in, and a continuous visible signal from, said first vehicle visible light generating electrical energy to optical energy transducer apparatus;
said electrical circuit apparatus including an electronic switch with a high input impedance circuit, said electronic switch actvated by input of minimum dc voltage from the throttle position sensor of a first vehicle, and outputing a dc current capable of energizing and closing said first continuously closable electrical switch;
said first continually closable switch may alternativly be operated by the idle position of the throttle control cable or linkage;
said electrical circuit apparatus including a second continuously openable switch, said openable switch in series with said first continuously closable switch, and responsive to said first vehicle braking action;
said first vehicle brake on condition operating said second switch that opens the electrical conductive path between said throttle responsive first closable switch and said electrical to optical energy transducer;
said first vehicle cruise control on condition operating said second switch that opens the electrically conductive path between said throttle responsive first closable switch and said electrical to optical energy transducer.

2) The throttle position responsive status light apparatus of claim 1, and said visible light generating electrical energy to optical energy transducer apparatus of claim 1, are responsive to the on condition of said first vehicle brake system, where an on condition of said first vehicle brakes will disconnect said first vehicle electrical energy source from said optical transducer apparatus.

3) The throttle position responsive status light apparatus of claim 1, and said visible light generating electrical energy to optical energy transducer apparatus of claim 1, are responsive to the on condition of said first vehicle cruise control system, where an on condition of said system will disconnect said first vehicle electrical energy source from said optical transducer apparatus.

4) The throttle position responsive status light apparatus of claim 1, wherein said visible light generating electrical energy to optical enenergy transducer apparatus of claim 1, are also responsive to, and co-operate with, said first vehicle directional signal system;
said cooperative use of said first and second electrical to optical energy transducers as throttle responsive status lights, and as directional signal lights, accomplished by duplicate second auxiliary electronic circuits,
said second auxiliary electronic circuits comprised of third electric relays and first electronic capacitors connected in parallel, said parallel circuits connected to said first and second directional lamp circuits through first diodes;
said first vehicle directional signal system connected to said first and second electrical to optical energy transducers through second diodes, the anode of said second diodes also connected to the anodes of said first diodes;
said first vehicle-received source of electrical energy of claim 1 conducting through said first continually closable electric switch of claim 1, and said second continually openable switch of claim 1, thence through the continually openable switches controlled by said third electric relays; thence though third diodes to said first and second electrical to optical energy transducers.

5) The first continuously closable electric switch of claim 1 may be a normally open relay contact, said relay coil energized by said first electronic switch of claim 1, or through a fourth switch operated by the idle position of said first vehicle accelerator control cable or linkage;
alternatively, said fourth switch may close when the throttle control cable is in the idle position and directly conduct the first vehicle-received source energy into the electrical circuit apparatus of claim 1, and to the optical energy transducer apparatus of claim 1;
said fourth switch may be solid state, magnetic, electro-mechanical, reed, mercury, or any other type of switch deemed suitable for the application.

6) The throttle responsive signal light electrical energy to optical energy transducer apparatus of claim 1 may be one or more incandescent filament lamps, one or more captive ionized gas lamps, or one or more light emitting diode sources.

7) The throttle responsive signal light electrical energy to optical energy transducer apparatus of claim 1 may include a plurality of transducer elements mounted on said first vehicle, and disposed in a rear facing selected physical array.
